(19) United States
(12) Patent Application Publication
(10) Pub. No.: US 2016/0261202 A1
(43) Pub. Date: Sep. 8, 2016

(54) ISOLATED DC/DC CONVERTER, FEEDBACK CIRCUIT THEREOF, POWER SUPPLY DEVICE, POWER SUPPLY ADAPTOR, AND ELECTRONIC DEVICE USING THE SAME

(71) Applicant: ROHM CO., LTD., Ukyo-Ku (JP)

(72) Inventors: Hiroki KIKUCHI, Ukyo-Ku (JP); Ryo SHIMIZU, Ukyo-Ku (JP)

(21) Appl. No.: 15/057,522

(22) Filed: Mar. 1, 2016

(30) Foreign Application Priority Data
Mar. 5, 2015 (JP) 2015-043877

(51) Int. Cl. H02M 3/335

(52) U.S. Cl. CPC H02M 3/33523

(57) ABSTRACT

A feedback circuit includes: an input terminal which receives a voltage detection signal corresponding to an output voltage of a DC/DC converter; an output terminal connected to an input side of the photo coupler; a ground terminal; a shunt regulator configured to amplify an error between the voltage detection signal and its target voltage and pull up a first current corresponding to the error from the input side of the photo coupler via the output terminal; and a protection circuit configured to pull up a second current from the input side of the photo coupler via the output terminal when an abnormality of the secondary side of the DC/DC converter is detected. The feedback circuit is packaged into a single module.

### CROSS-REFERENCE TO RELATED APPLICATION

This application is based upon and claims the benefit of priority from Japanese Patent Application No. 2015-043877, filed on Mar. 5, 2015, the entire contents of which are incorporated herein by reference.

### TECHNICAL FIELD

The present disclosure relates to a DC/DC converter.

### BACKGROUND

A variety of home appliances such as televisions and refrigerators are operated with commercial AC power supplied from the outside. Electronic devices such as laptop computers, mobile phone terminals and tablet terminals can be also operated with commercial AC power, or their internal batteries can be charged with commercial AC power. Such home appliances and electronic devices (hereinafter collectively referred to as electronic devices) incorporate a power supply device (an AC/DC converter) for converting a commercial AC (alternating current) voltage to a DC (direct current) voltage. Alternatively, in some cases, an AC/DC converter may be incorporated in power supply adaptors (AC adaptors) outside electronic devices.

FIG. 1 is a block diagram illustrating a basic configuration of an AC/DC converter 100r reviewed by the present inventors. The AC/DC converter 100r mainly includes a filter 102, a rectification circuit 104, a smoothing capacitor 106 and a DC/DC converter 200r.

A commercial AC voltage V_{AC} is input to the filter 102 via a fuse and an input capacitor (not shown). The filter 102 removes a noise from the commercial AC voltage V_{AC}. The rectification circuit 104 is a diode bridge circuit for full-wave rectifying the commercial AC voltage V_{AC}. An output voltage of the rectification circuit 104 is converted to a DC voltage V_{IN} by being smoothed by the smoothing capacitor 106.

The isolated DC/DC converter 200r receives the DC voltage V_{IN} input at its input terminal P1 to drop the DC voltage V_{IN} down, and supplies an output voltage V_{OUT}, which is stabilized at a target value, to a load (not shown) connected between its output terminal P2 and its ground terminal P3.

The DC/DC converter 200r includes a primary side controller 202, a photo coupler 204, a shunt regulator 206, an output circuit 210 and other circuit components. The output circuit 210 includes a transformer T1 having a primary winding W1 and a secondary winding W2, a diode D1, an output capacitor C1 and a switching transistor M1. The topology of the output circuit 210 is the same as that of a typical flyback converter and therefore will not be explained for the sake of brevity.

As the switching transistor M1 is switched, the input voltage V_{IN} is dropped down to generate the output voltage V_{OUT}. The primary side controller 202 stabilizes the output voltage V_{OUT} at a target value by adjusting a duty ratio of switching of the switching transistor M1.

A cathode terminal of the shunt regulator 206 is connected to a light emitting element (light emitting diode) at the input side of the photo coupler 204 and an anode terminal is grounded. The output voltage V_{OUT} of the DC/DC converter 200r is divided by resistors R1 and R2. A voltage (voltage detection signal) V_{OUT}_{_}_{S} obtained as a result of the division is input to an input terminal (REF terminal) of the shunt regulator 206. The shunt regulator 206 amplifies an error between the voltage detection signal V_{OUT}_{_}_{S} and a predetermined reference voltage V_{REF} (not shown), and draws (sink) an error current I_{ERR} corresponding to the error from the light emitting diode at the input side of the photo coupler 204.

A feedback current I_{FB} corresponding to the error current I_{ERR} at a secondary side is flown into a light receiving element (phototransistor) at the output side of the photo coupler 204. The feedback current I_{FB} is smoothed by a resistor and a capacitor and is input to a feedback (FB) terminal of the primary side controller 202. The primary side controller 202 adjusts the duty cycle of the switching transistor M1 based on a voltage (feedback voltage) V_{FB} of the FB terminal.

The present inventors have reviewed the isolated DC/DC converter and have recognized the following problems. The DC/DC converter 200r of FIG. 1 has no circuit protection means for protecting the DC/DC converter 200r when there is an overvoltage condition, a temperature abnormality, an overcurrent condition and so on in the secondary side. FIG. 2 is a circuit diagram of a DC/DC converter 200s reviewed by the present inventors. The DC/DC converter 200s includes a protection circuit 208 and a photo coupler 205, which are disposed at the secondary side, in addition to the DC/DC converter 200r of FIG. 1. Upon detecting the overvoltage conditions, temperature abnormality, overcurrent conditions and so on, the protection circuit 208 drives a light emitting element at the input side of the photo coupler 205. When the photo coupler 205 is driven, a current is flown into a light receiving element at the output side of the photo coupler 205. A primary side controller 202s has a fail detection terminal FAIL, and stops the switching of the switching transistor M1 when the current is flown into the photo coupler 205.

The DC/DC converter 200s of FIG. 2 is able to protect the circuit from abnormality which may occur at the secondary side. However, in order to notify the primary side that the abnormality occurs, in addition to the photo coupler 204 for feedback, it is necessary to provide the photo coupler 205 for fail notification, which may result in an increase in costs.

In addition, the primary side controller 202s requires an additional FAIL terminal. However, typical primary side controllers are not provided with such a terminal. Therefore, a customized IC is required, resulting in an increase in costs.

### SUMMARY

The present disclosure provides some embodiments of a DC/DC converter with a simple and inexpensive structure, which is capable of detecting abnormality at a secondary side and protecting a circuit even when an abnormality occurs.

According to one embodiment of the present disclosure, a feedback circuit is disposed at a secondary side of an isolated DC/DC converter. The DC/DC converter includes: a transformer having a primary winding and a secondary winding; a switching transistor connected to the primary winding of the transformer; a rectification element connected to the secondary winding of the transformer; a photo coupler; a primary side controller which is connected to an output side of the photo coupler and is configured to switch the switching transistor in response to a feedback signal from the photo coupler; and the feedback circuit configured to drive the photo coupler. The feedback circuit includes: an input terminal which receives a voltage detection signal corresponding to an output voltage of the DC/DC converter; an output terminal connected to an input side of the photo coupler; a ground terminal; a shunt regulator configured to amplify an error between the voltage detection signal and its target voltage and draw a first current corresponding to the error from the input side of the photo coupler via the output terminal; and a protection circuit configured to draw a second current from the input side of the photo coupler via the output terminal when abnormality of the secondary side of the DC/DC converter is detected. The feedback circuit is packaged in a single module.

The photo coupler is driven by the second current for circuit protection, in addition to the first current for feedback control of an output voltage. By driving the photo coupler by means of the second current when the abnormality is detected, feedback control is applied in such a way that a duty ratio of the switching transistor at the primary side is zeroed, thereby protecting the feedback circuit. With this configuration, since the photo coupler for feedback is used to inform the primary side of the abnormality of the secondary side, a need of a photo coupler for circuit protection is eliminated. In addition, the primary side controller requires no additional pin (terminal).

The protection circuit may include a protection transistor having one end connected to the output terminal and the other end connected to the ground terminal. The protection transistor may be turned on when the abnormality is detected. Since the protection transistor is turned on when the abnormality is detected, the second current can be supplied to the photo coupler.

The DC/DC converter may further include an abnormality detection circuit which is disposed at the secondary side and is configured to generate an abnormality detection signal to be asserted when the abnormality is detected. The feedback circuit may further include a sense terminal to which the abnormality detection signal is input. The protection circuit may draw the second current when the abnormality detection signal is asserted.

The abnormality detection circuit may be configured to detect at least one of an overvoltage state and a high temperature state of the secondary side of the DC/DC converter.

The feedback circuit may further include an abnormality detection circuit which is configured to determine whether an abnormality is present in the secondary side and assert an abnormality detection signal when the abnormality is detected. The protection circuit may draw the second current when the abnormality detection signal is asserted.

The feedback circuit may further include a sense terminal to which a sense signal indicating a state of the secondary side of the DC/DC converter is input. The abnormality detection circuit may determine whether the abnormality is present, based on an electrical state of the sense terminal.

The feedback circuit may further include: a sense terminal to which a sense signal indicating a state of the secondary side of the DC/DC converter is input; and an abnormality detection comparator configured to compare a voltage of the sense terminal with a predetermined threshold voltage and generate an abnormality detection signal indicating a result of the comparison. The protection circuit may draw the second current when the abnormality detection signal is asserted.

An overvoltage detection signal corresponding to an output voltage of the DC/DC converter may be input to the sense terminal. The abnormality detection comparator may detect an overvoltage state.

A temperature sensing element may be connected to the sense terminal. The abnormality detection comparator may detect high temperature abnormality.

The shunt regulator may include: a differential amplifier configured to amplify the error between the voltage detection signal and its target voltage; and an output transistor having one end connected to the output terminal, the other end connected to the ground terminal, and a control terminal to which an output signal of the differential amplifier is input.

According to another embodiment of the present disclosure, there is provided a DC/DC converter including: a transformer having a primary winding and a secondary winding; a switching transistor connected to the primary winding of the transformer; a rectification element connected to the secondary winding of the transformer; a photo coupler; a primary side controller which is connected to an output side of the photo coupler and is configured to switch the switching transistor in response to a feedback signal from the photo coupler; and one of the above-described feedback circuits, which is configured to drive the photo coupler.

The DC/DC converter may be of a flyback type or of a forward type.

According to another embodiment of the present disclosure, there is provided a power supply device including: a filter configured to filter a commercial AC voltage; a diode rectification circuit configured to full-wave rectify an output voltage of the filter; a smoothing capacitor configured to generate a DC input voltage by smoothing an output voltage of the diode rectification circuit; and the above-described DC/DC converter, which is configured to drop down the DC input voltage and supply the dropped-down voltage to a load.

According to another embodiment of the present disclosure, there is provided an electronic device including: a load; a filter configured to filter a commercial AC voltage; a diode rectification circuit configured to full-wave rectify an output voltage of the filter; a smoothing capacitor configured to generate a DC input voltage by smoothing an output voltage of the diode rectification circuit; and the above-described DC/DC converter, which is configured to drop down the DC input voltage and supply the dropped-down DC input voltage to a load.

According to another embodiment of the present disclosure, there is provided an AC adaptor including: a filter configured to filter a commercial AC voltage; a diode rectification circuit configured to full-wave rectify an output voltage of the filter; a smoothing capacitor configured to generate a DC input voltage by smoothing an output voltage of the diode rectification circuit; and the above-described DC/DC converter, which is configured to drop down the DC input voltage to generate a DC output voltage.

Any combinations of the above-described elements or any replacement of elements or representations in the present disclosure among methods, apparatuses and systems are effective as embodiments of the present disclosure.

### BRIEF DESCRIPTION OF THE DRAWINGS

FIG. 1 is a block diagram illustrating the basic configuration of an AC/DC converter reviewed by the present inventors.

FIG. 2 is a circuit diagram of a DC/DC converter reviewed by the present inventor.

FIG. 3 is a circuit diagram of a DC/DC converter including a feedback integrated circuit according to a first embodiment.

FIG. 4 is a first operation waveform diagram of the DC/DC converter of FIG. 3.

FIG. 5 is a second operation waveform diagram of the DC/DC converter of FIG. 3.

FIG. 6 is a detailed circuit diagram of a feedback IC of FIG. 3.

FIG. 7 is a circuit diagram of a DC/DC converter including a feedback IC according to a second embodiment.

FIG. 8 is a circuit diagram illustrating the configuration of the feedback IC.

FIG. 9 is a circuit diagram of a feedback IC according to a modification.

FIG. 10 is a circuit diagram of a feedback IC according to a third embodiment.

FIG. 11 is a view illustrating an AC adaptor including an AC/DC converter.

FIGS. 12A and 12B are views illustrating an electronic device including an AC/DC converter.

FIGS. 13A and 13B are circuit diagrams of a feedback IC according to a third modification.

### DETAILED DESCRIPTION

Preferred embodiments of the present disclosure will now be described in detail with reference to the drawings. Throughout the drawings, the same or similar elements, members and processes are denoted by the same reference numerals and explanation of which may not be repeated. The disclosed embodiments are provided for the purpose of illustration, not limitation, of the present disclosure and all features and combinations thereof described in the embodiments cannot be necessarily construed to describe the substance of the present disclosure.

In the specification, the phrase “connection of a member A and a member B” is intended to include direct physical connection of the member A and the member B as well as indirect connection thereof via other member as long as the other member has no substantial effect on the electrical connection of the member A and the member B. Similarly, the phrase “interposition of a member C between a member A and a member B” is intended to include direct connection of the member A and the member C or direct connection of the member B and the member C as well as indirect connection thereof via other member as long as the other member has no substantial effect on the electrical connection of the member A, the member B and the member C.

### First Embodiment

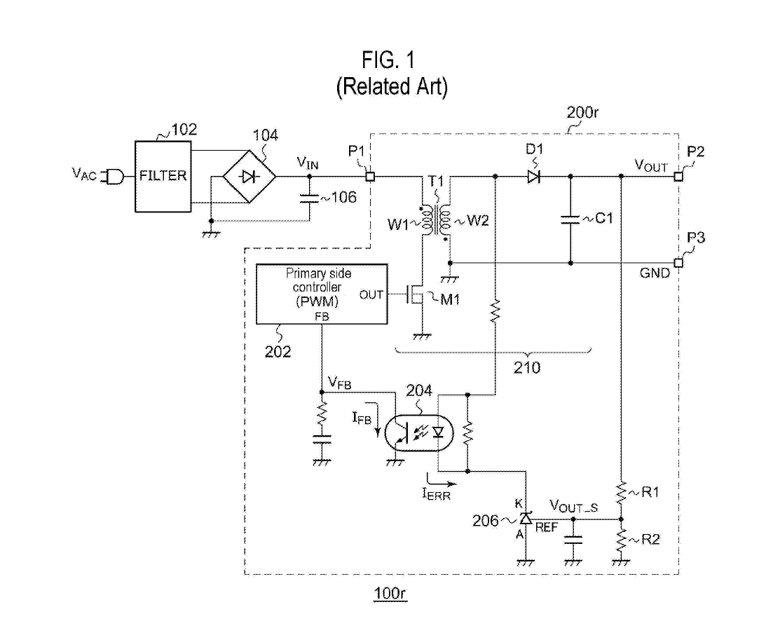

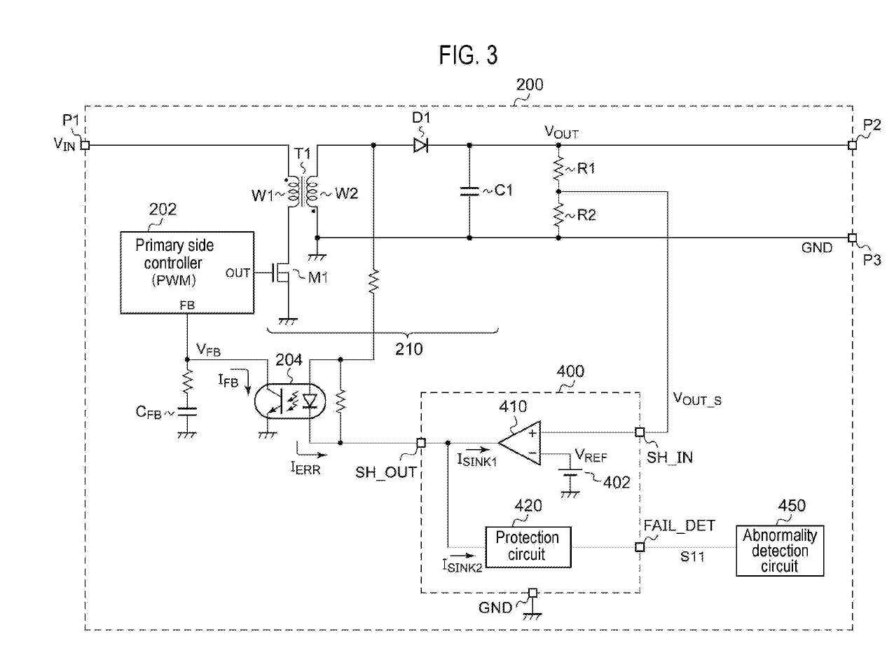

FIG. 3 is a circuit diagram of a DC/DC converter 200 including a feedback integrated circuit (feedback IC) 400 according to a first embodiment. Like the DC/DC converter 200r of FIG. 1, the DC/DC converter 200 can be also used for an AC/DC converter.

The DC/DC converter 200 includes an output circuit 210, a primary side controller 202, a photo coupler 204, a feedback IC 400 and an abnormality detection circuit 450. The DC/DC converter 200 has the same basic configuration as that of the DC/DC converter 200r of FIG. 1.

The feedback IC 400 is placed at the secondary side of the DC/DC converter 200 and drives the photo coupler 204 in such a way that an output voltage V_{OUT} approaches its target voltage.

The feedback IC 400 has an input (SHIN) terminal of a shunt regulator, an output (SH_OUT) terminal of the shunt regulator, and a ground (GND) terminal. The feedback IC 400 is integrated on a single semiconductor substrate and is housed in a single package. The SHIN terminal receives a voltage detection signal V_{OUT}_{_}_{S} in response to the output voltage V_{OUT} of the DC/DC converter 200. The SH_OUT terminal is connected to a light emitting diode at the input side of the photo coupler 204. The GND terminal is grounded.

The feedback IC 400 includes a reference voltage source 402, a shunt regulator 410 and a protection circuit 420. The reference voltage source 402 generates a predetermined reference voltage V_{REF}. The shunt regulator 410 amplifies an error between the voltage detection signal V_{OUT}_{_}_{S} and its target voltage V_{REF}, and draws (sink) a first current I_{SINK1} corresponding to the error from the input side of the photo coupler 204 via the SH_OUT terminal.

Upon detecting an abnormality of the secondary side of the DC/DC converter 200, the protection circuit 420 draws a second current I_{SINK2} from the light emitting diode at the input side of the photo coupler 204 via the SH_OUT terminal.

In this embodiment, the DC/DC converter 200 further includes an abnormality detection circuit 450 which is placed at the secondary side and generates an abnormality detection signal S11 asserted (for example, with a high level) when the abnormality is detected. Examples of the abnormality to be detected by the abnormality detection circuit 450 may include, but are not limited to, overvoltage abnormality of the output voltage V_{OUT}, overcurrent abnormality of a load current, shunt abnormality of an output terminal P2, open abnormality, high temperature (overheating) abnormality, etc. The abnormality detection circuit 450 detects at least one of these abnormalities. The abnormality detection circuit 450 is not particularly limited in its configuration but may employ one of those known in the art.

The feedback IC 400 of FIG. 3 further includes a detection (FALL_DET) terminal to which the abnormality detection signal S11 is input. When the abnormality detection signal S11 is asserted, the protection circuit 420 draws the second current I_{SINK2}. In order to ensure a stable circuit operation, the protection circuit 420 draws the second current I_{SINK2} when the assert state of the abnormality detection signal S11 lasts for a predetermined timer time τ_{TIMER}.

After the abnormality detection signal S11 is once asserted, until the protection circuit 420 is reset from the outside, the protection circuit 420 may latch the status of the abnormality detection signal S11 and continue to draw the second current I_{SINK2} (timer latch).

Alternatively, the protection circuit 420 may include an auto-restart function and stop the drawing of the second current I_{SINK2} after lapse of a predetermined restart time when the abnormality detection signal S11 is once asserted (auto-restart). The protection circuit 420 may be configured to be switched between the timer latch and the auto-restart depending on values of a register and a fuse.

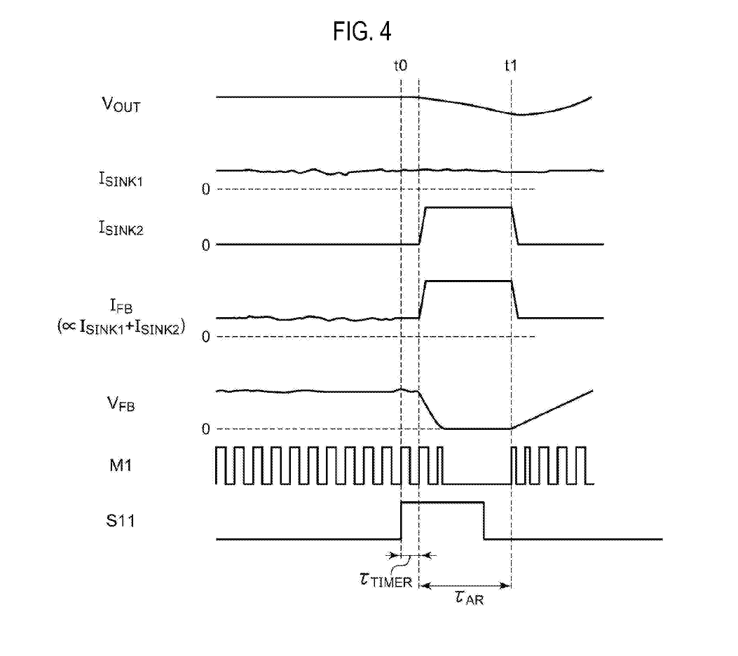

The configurations of the feedback IC 400 and the DC/DC converter 200 including the same have been described above. Subsequently, the operation thereof will be described. FIG. 4 is a first operation waveform diagram of the DC/DC converter 200 of FIG. 3. The operation of the feedback IC 400 with an auto-restart function is shown in FIG. 4.

Prior to time t0, the DC/DC converter 200 is in a normal state. In the normal state, the abnormality detection signal S11 is negative (i.e., has a low level), and the second current I_{SINK2} is zero. In the normal state, the amount of the first current I_{SINK1} is regulated by the shunt regulator 410 to approach the output voltage V_{OUT} to the target value. A feedback current I_{FB} generated by the photo coupler 204 corresponds to the sum of the first current I_{SINK1} and the second current I_{SINK2}. In the normal state, since I_{SINK2}=0, the feedback current I_{FB} corresponds to the first current I_{SINK1}. In the primary side, a feedback voltage V_{FB} is generated according to the feedback current I_{FB}. The primary side controller 202 switches the switching transistor M1 with a duty ratio according to the feedback voltage V_{FB}. As a result, the output voltage V_{OUT} is feedback-controlled to approach the target value.

When an abnormality is detected at time t1, the abnormality detection signal S11 is asserted (i.e., has a high level). Then, at time t1 after the lapse of a predetermined time τ_{TIMER}, the second current I_{SINK2} is supplied to the light emitting diode of the photo coupler 204 and the feedback current I_{FB} is accordingly increased. When the feedback current I_{FB} is increased, a capacitor C_{FB} connected to the FB terminal of the primary side controller 202 is discharged and the feedback voltage V_{FB} is accordingly decreased to around 0V. As a result, the duty ratio of the switching of the switching transistor M1 is also decreased to around 0, eventually stopping the switching.

At time t2 after lapse of an auto-restart time τ_{AR} from time t1, the protection circuit 420 returns the second current I_{SINK2} to zero. In this case, if the abnormality detection signal S11 is negated as shown in FIG. 4, then the protection circuit 420 returns to normal operation. If the abnormality detection signal S11 is still asserted at time t2, the photo coupler 204 is driven again by the second current I_{SINK2} and the switching of the switching transistor M1 is stopped.

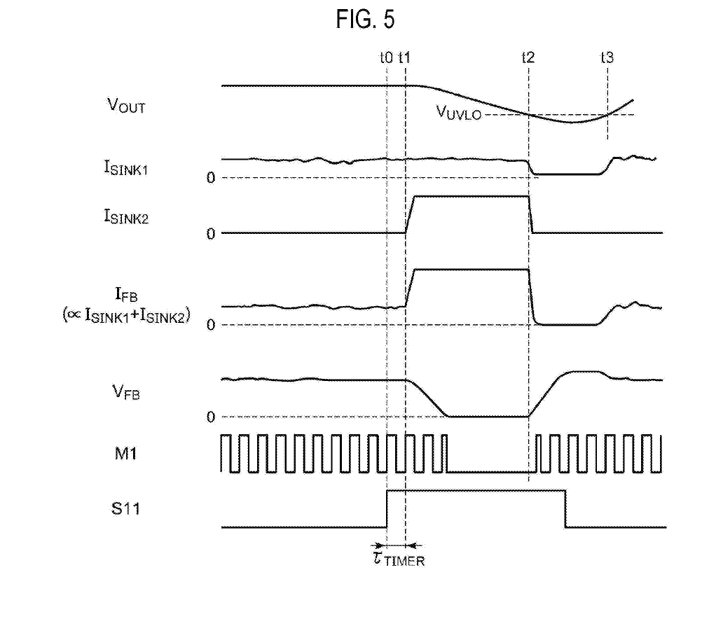

FIG. 5 is a second operation waveform diagram of the DC/DC converter 200 of FIG. 3. The operation of the feedback IC 400 with a latch function is shown in FIG. 5. The operation prior to time t0 is the same as that of FIG. 4.

In the configuration where the protection circuit 420 latches the abnormality detection signal S11, the second current I_{SINK2} begins to flow after lapse of a time τ_{TIMER} after the abnormality detection signal S11 is asserted at time t0. Thereafter, the second current I_{SINK2} continues to flow, the stop state of the switching of the switching transistor M1 lasts, and the output voltage V_{OUT} continues to decrease. Since the feedback IC 400 operates with the output voltage V_{OUT} as power, the feedback IC 400 becomes disabled when the output voltage V_{OUT} drops to a low lockout voltage V_{UVLO} corresponding to an operation voltage (time t2). As a result, the second current I_{SINK2} does not flow, the switching of the switching transistor M1 resumes, and the output voltage V_{OUT} begins to rise.

At time t3, when the output voltage V_{OUT} is higher than the low lockout voltage V_{UVLO}, the feedback IC 400 is powered-on and reset. In this case, if the abnormality detection signal S11 is de-asserted as shown in FIG. 5, then the protection circuit 420 returns to normal operation. If the abnormality detection signal S11 is still asserted at time t3, the photo coupler 204 is driven again by the second current I_{SINK2} and the switching of the switching transistor M1 is stopped.

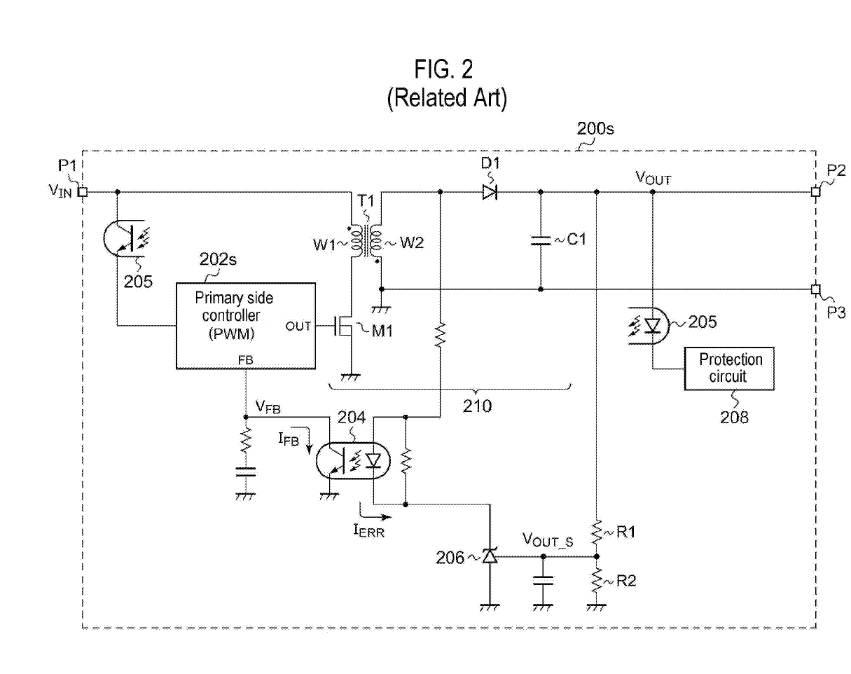

The operation of the DC/DC converter 200 has been described above. Subsequently, advantages thereof will be described. In this embodiment, the protection circuit 420 is built in the feedback IC 400 and the photo coupler 204 is driven with the second current I_{SINK2} by the protection circuit 420 if there occurs abnormality in the secondary side. This allows the feedback current I_{FB} to be increased when the abnormality occurs, thereby allowing the feedback voltage V_{FB} input to the primary side controller 202 to be varied in such a way that the duty ratio of the switching transistor M1 becomes zero. Therefore, there is no need of the photo coupler 205 required for the DC/DC converter 200s of FIG. 2, thereby simplifying the circuit configuration and reducing production costs.

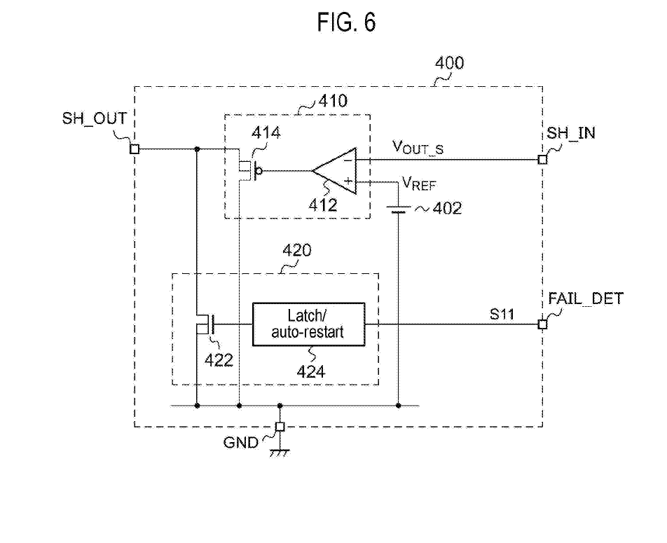

FIG. 6 is a detailed circuit diagram of the feedback IC 400 of FIG. 3. The shunt regulator 410 includes a differential amplifier 412 and an output transistor 414. The output transistor 414 has one end connected to the SHOUT terminal and the other end connected to the GND terminal. The differential amplifier 412 amplifies an error between the voltage detection signal V_{OUT}_{_}_{S} input to the SHIN terminal and its target voltage V_{REF}. An output signal of the differential amplifier 412 is input to a control terminal of the output transistor 414.

The output transistor 414 may be, for example, a P channel MOSFET or a PNP type bipolar transistor. In this case, the voltage detection signal V_{OUT}_{_}_{S} and the target voltage V_{REF} are input to the inverted input terminal (−) and non-inverted input terminal (+) of the differential amplifier 412, respectively.

On the contrary, the output transistor 414 may be an N channel MOSFET or an NPN type bipolar transistor. In this case, the target voltage V_{REF} and the voltage detection signal V_{OUT}_{_}_{S} may be input to the inverted input terminal (−) and non-inverted input terminal (+) of the differential amplifier 412, respectively.

The protection circuit 420 includes a protection transistor 422 and a latch/auto-restart circuit 424.

The protection transistor 422 is interposed between the SH_OUT terminal and the GND terminal. The latch/auto-restart circuit 424 receives the abnormality detection signal S11 from a FAIL_DET terminal. For the protection circuit 420 with a latch function, if a state where the abnormality detection signal S11 is asserted lasts for a determination time, the latch/auto-restart circuit 424 latches that state and continues to turn on the protection transistor 422. If the protection transistor 422 is an N channel MOSFET or an NPN type bipolar transistor, when the abnormality detection signal S11 is asserted, the latch/auto-restart circuit 424 makes a gate voltage of the protection transistor 422 a high level or supplies a current to a base of the protection transistor 422.

For the protection circuit 420 with an auto-restart function, when the abnormality detection signal S11 is asserted, the latch/auto-restart circuit 424 turns on the protection transistor 422, and releases the turning-on of the protection transistor 422 after lapse of an auto-restart time, regardless of the state of the abnormality detection signal S11.

The protection transistor 422 may be configured with a P channel MOSFET or a PNP type bipolar transistor.

The configurations of the shunt regulator 410 and the protection circuit 420 of the feedback IC 400 are not limited to those shown in FIG. 6, but it is to be understood by those skilled in the art that various modifications to the configurations may be made and fall within the scope of the present disclosure.

### Second Embodiment

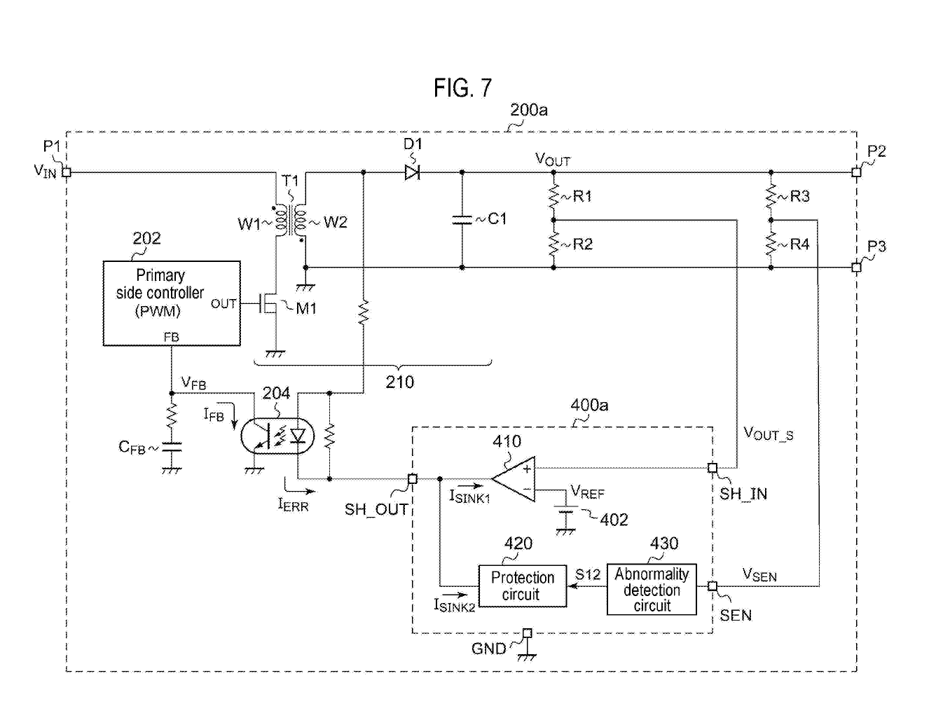

FIG. 7 is a circuit diagram of a DC/DC converter 200a including a feedback IC 400a according to a second embodiment. The feedback IC 400a according to the second embodiment includes some or all of the functions of the abnormality detection circuit 450 of the first embodiment.

The feedback IC 400a further includes a sense (SEN) terminal to which a sense signal V_{SEN} indicating a state of the secondary side of the DC/DC converter 200a is input, instead of the FAIL terminal. An abnormality detection circuit 430 determines whether or not abnormality occurs in the secondary side, based on the sense signal V_{SEN} input to the SEN terminal, and asserts an abnormality detection signal S12 if the abnormality is detected.

Examples of the abnormality to be detected by the abnormality detection circuit 430 may include, but are not limited to, overvoltage abnormality of the output voltage V_{OUT}, overcurrent abnormality of a load current, shunt abnormality of an output terminal P2, open abnormality, high temperature (overheating) abnormality, etc. The abnormality detection circuit 430 detects at least one of these abnormalities.

Overvoltage detection is illustrated in FIG. 7. The DC/DC converter 200a of FIG. 7 includes resistors R3 and R4. The resistors R3 and R4 divide the output voltage V_{OUT} to generate an overvoltage sense signal V_{SEN}. The abnormality detection circuit 430 may detect an overvoltage state by comparing the signal V_{SEN} with an overvoltage detection threshold voltage V_{OVP}.

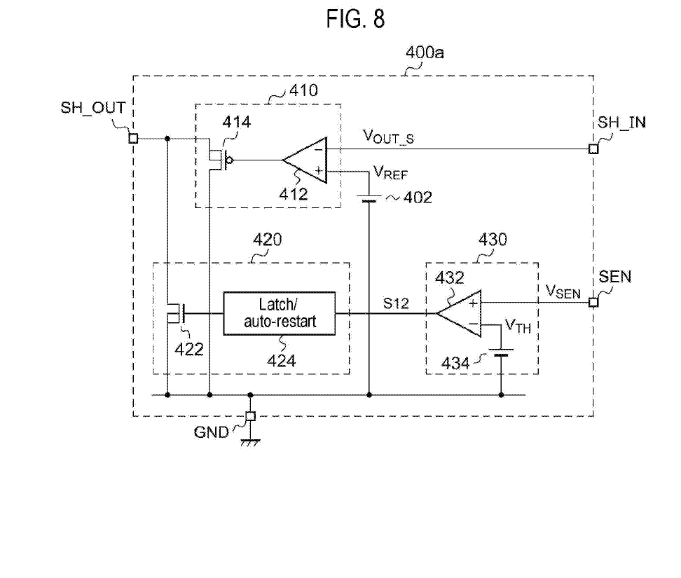

FIG. 8 is a circuit diagram illustrating the configuration of the feedback IC 400a. The abnormality detection circuit 430 includes a voltage source 434 for generating a predetermined threshold voltage V_{TH} and an abnormality detection comparator 432 for comparing the voltage V_{SEN} of the SEN terminal with the threshold voltage V_{TH} and generating the abnormality detection signal S12 indicating a result of the comparison. The protection circuit 420 draws the second current I_{SINK2} when the abnormality detection signal S12 is asserted (for example, has a high level).

As described above, the abnormality detection circuit 430 may be an overvoltage detection circuit. In this case, the overvoltage sense signal V_{SEN} corresponding to the output voltage V_{OUT} of the DC/DC converter 200a is input to the SEN terminal. The threshold voltage V_{TH} generated by the voltage source 434 is the overvoltage detection threshold voltage V_{OVP}. When V_{SEN}>V_{OVP}, the abnormality detection comparator 432 asserts the abnormality detection signal S12. In addition, the resistors R3 and R4 of FIG. 7 may be built in the feedback IC 400a. In this case, the SEN terminal is connected to the output terminal P2.

An overcurrent protection circuit is implemented when the sense signal V_{SEN} corresponding to a load current is input to the SEN terminal of the feedback IC 400a of FIG. 8. Alternatively, abnormalities such as open failure and short failure can be also detected by setting the threshold voltage V_{TH} appropriately.

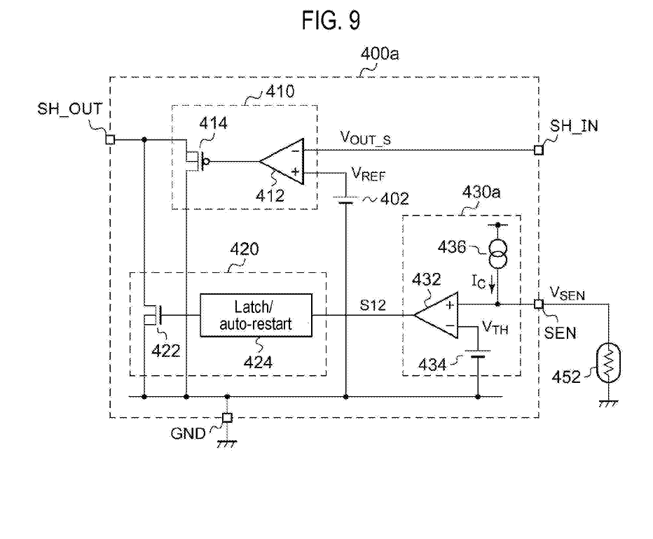

FIG. 9 is a circuit diagram of a feedback IC 400a according to a modification. The feedback IC 400a of FIG. 9 has the function of detecting high temperature abnormality and stopping the operation thereof at high temperature (thermal shutdown function). A thermistor 452 as a temperature sensing element is connected to the SEN terminal.

An abnormality detection circuit 430a includes a bias circuit 436 for biasing the thermistor 452, in addition to the abnormality detection comparator 432 and the voltage source 434. The bias circuit 436 may be a current source for supplying a current I_{C} or may be a resistor. The bias circuit 436 may be externally attached to the feedback IC 400a. In this case, the feedback IC 400a has the same configuration as that of FIG. 8.

If the thermistor 452 is a PTC (Positive Temperature Coefficient) thermistor having a positive temperature characteristic, the voltage V_{SEN} of the SEN terminal rises as the temperature rises. If the voltage V_{SEN} of the SEN terminal exceeds the threshold voltage V_{TH} determined depending on a temperature threshold, the abnormality detection signal S12 is asserted. The thermistor 452 may be an NTC (Negative Temperature Coefficient) thermistor. In this case, the inputs of the abnormality detection comparator 432 may be interchanged.

According to the second embodiment, by integrating the abnormality detection circuit 430a into the feedback IC 400a, it is possible to further reduce the number of externally-attached circuit components as compared to the configuration of FIG. 3, thereby simplifying the circuit configuration and reducing production costs.

In addition, by integrating the abnormality detection circuit 430a into the feedback IC 400a, it is possible to increase the precision of abnormality detection in comparison with the abnormality detection circuit 450 including discrete components and external circuit components.

### Third Embodiment

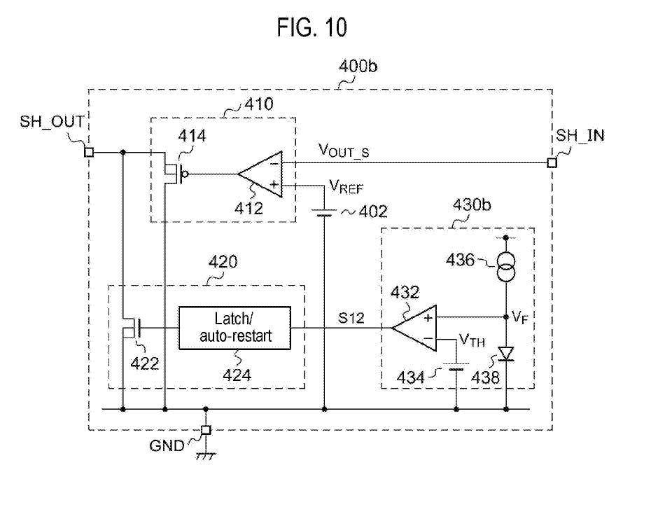

FIG. 10 is a circuit diagram of a feedback IC 400b according to a third embodiment. The feedback IC 400b has the thermal shutdown function, like the feedback IC 400a of FIG. 9. A temperature sensing element 438 of an abnormality detection circuit 430b is integrated into the feedback IC 400b and, therefore, the SEN terminal is omitted. The temperature sensing element 438 is, for example, a diode and its temperature characteristic of forward voltage V_{F} (negative temperature characteristic) is used.

With this configuration, it is possible to reduce the number of external components and further reduce production costs since the SEN terminal or the FAIL terminal is unnecessary.

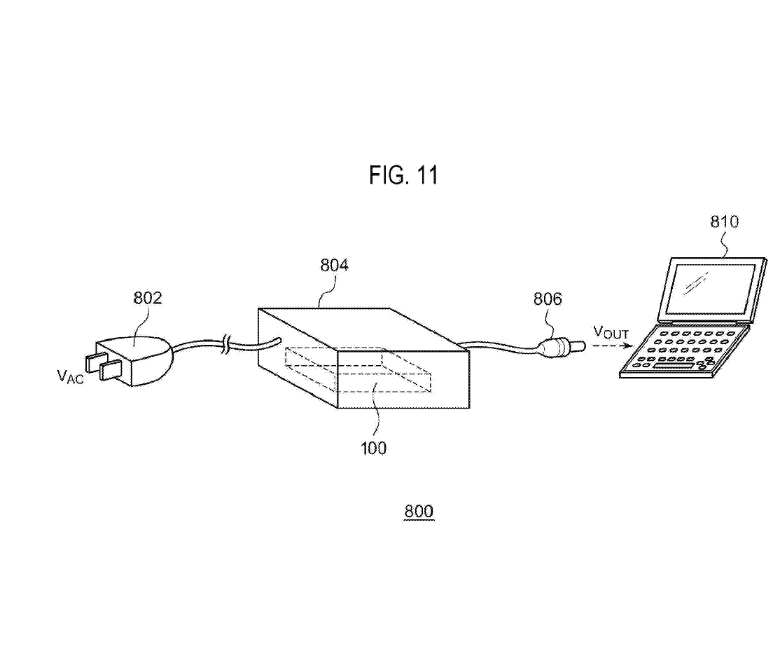

Subsequently, the use of the DC/DC converter 200 will be described. FIG. 11 is a view illustrating an AC adaptor 800 including an AC/DC converter 100. The AC adaptor 800 includes a plug 802, a housing 804 and a connector 806. The plug 802 receives a commercial AC voltage V_{AC} from an electrical outlet (not shown). The AC/DC converter 100 is embedded in the housing 804. A DC output voltage V_{OUT} generated by the AC/DC converter 100 is supplied to an electronic device 810 via the connector 806. Examples of the electronic device 810 may include a notebook PC, a digital camera, a digital video camera, a mobile phone, a portable audio player and the like.

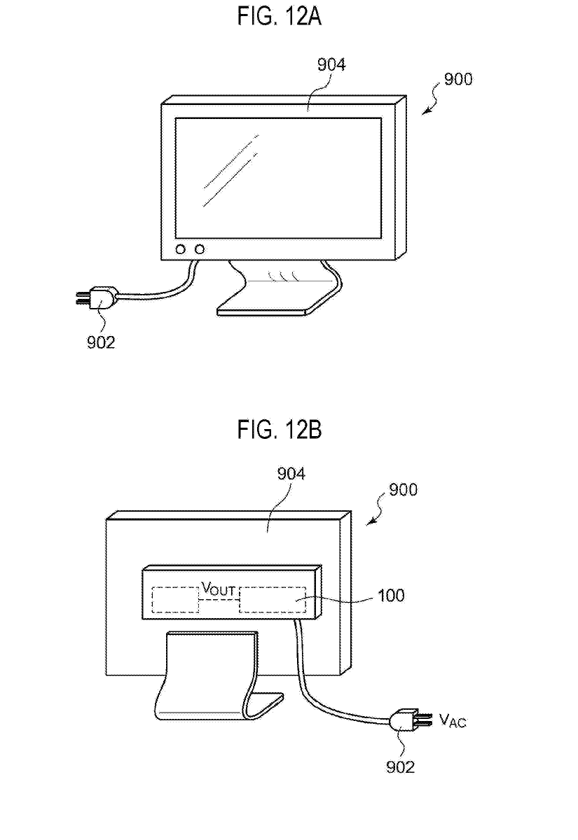

FIGS. 12A and 12B are views illustrating an electronic device 900 including the AC/DC converter 100. Although the electronic device 900 shown in FIGS. 12A and 12B is a display device, the type of the electronic device 900 is not particularly limited. For example, the electronic device may be an audio system, a refrigerator, a washing machine, a vacuum cleaner or other electronic devices with a power supply built in. A plug 902 receives a commercial AC voltage V_{AC} from an electrical outlet (not shown). The AC/DC converter 100 is embedded in a housing 904. A DC output voltage V_{OUT} generated by the AC/DC converter 100 is supplied to a load such as a microcomputer, a DSP (Digital Signal Processor), a power supply circuit, a lighting device, an analog circuit, a digital circuit or the like, which is equipped in the housing 904.

The present disclosure describes some embodiments as above. The disclosed embodiments are exemplary, and thus, it should be understood by those skilled in the art that various modifications to combinations of the elements or processes above may be made and such modifications will also fall within the scope of the present disclosure. Some exemplary modifications will be described below.

### (First Modification)

Although the DC/DC converter 200 of a diode rectification type has been illustrated in the above embodiments, the present disclosure can also be applied to a DC/DC converter of a synchronous rectification type. The synchronous rectification-typed DC/DC converter includes a synchronous rectification transistor instead of the diode D1 and further includes a synchronous rectification controller (secondary side controller) for switching the synchronous rectification transistor. The feedback IC 400 may be built in a single module, together with the secondary side controller.

In addition, although the flyback converter has been illustrated in the above embodiments, the present disclosure can be applied to a forward converter. In addition, at least one of the switching transistor and the synchronous rectification transistor may be a bipolar transistor or an IGBT.

### (Second Modification)

The feedback IC 400 may detect a plurality of abnormalities. That is, the number of the above-described abnormality detection circuit 430 may be two or more which are optionally used in combination.

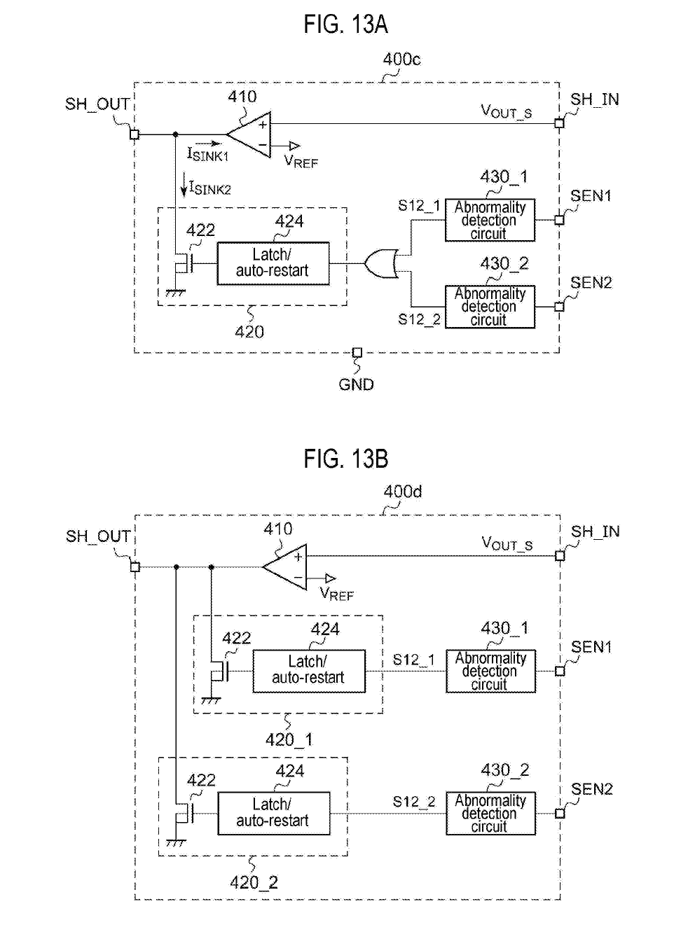

FIGS. 13A and 13B are circuit diagrams of a feedback IC according to a third modification. A feedback IC 400c of FIG. 13A includes a plurality of abnormality detection circuits 430_1 and 430_2 and a plurality of sense terminals SEN_1 and SEN_2. For example, the abnormality detection circuit 430_1 detects an overvoltage and the abnormality detection circuit 430_2 detects high temperature abnormality. Abnormality detection signals S12_1 and S12_2 from the abnormality detection circuits 430_1 and 430_2 are logically synthesized by a logic gate (for example, an OR gate) 440. When an output of the logic gate 440 is asserted, the protection circuit 420 turns on the protection transistor 422.

A feedback IC 400d of FIG. 13B is provided with different protection circuits 420 for different abnormality detection circuits 430.

Each of the abnormality detection circuits 430_1 and 430_2 may have the configuration of one of the first to third embodiments. In other words, the abnormality detection circuit 430 may be omitted, the SEN terminal may be replaced with the FAIL terminal, and the abnormality detection circuit 450 may be externally attached. Alternatively, the SEN terminal may be omitted as illustrated in FIG. 10.

According to some embodiments of the present disclosure, it is possible to provide an isolated DC/DC converter with a simple and inexpensive structure, which is capable of detecting abnormality at a secondary side and protecting a circuit even when abnormality occurs.

While certain embodiments have been described using specific language, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A feedback circuit disposed at a secondary side of an isolated DC/DC converter, wherein the DC/DC converter includes:
a transformer having a primary winding and a secondary winding;
a switching transistor connected to the primary winding of the transformer;
a rectification element connected to the secondary winding of the transformer;
a photo coupler;
a primary side controller which is connected to an output side of the photo coupler and is configured to switch the switching transistor in response to a feedback signal from the photo coupler; and
the feedback circuit configured to drive the photo coupler,
the feedback circuit comprising:
an input terminal which receives a voltage detection signal corresponding to an output voltage of the DC/DC converter;
an output terminal connected to an input side of the photo coupler;
a ground terminal;
a shunt regulator configured to amplify an error between the voltage detection signal and its target voltage and draw a first current corresponding to the error from the input side of the photo coupler via the output terminal; and
a protection circuit configured to draw a second current from the input side of the photo coupler via the output terminal when an abnormality of the secondary side of the DC/DC converter is detected, and
wherein the feedback circuit is packaged in a single module.

2. The feedback circuit of claim 1, wherein the protection circuit includes a protection transistor having one end connected to the output terminal and the other end connected to the ground terminal, the protection transistor being turned on when the abnormality is detected.

3. The feedback circuit of claim 1, wherein the DC/DC converter further includes an abnormality detection circuit which is disposed at the secondary side and is configured to generate an abnormality detection signal to be asserted when the abnormality is detected,
the feedback circuit further comprising a sense terminal to which the abnormality detection signal is input and
wherein the protection circuit draws the second current when the abnormality detection signal is asserted.

4. The feedback circuit of claim 3, wherein the abnormality detection circuit is configured to detect at least one of an overvoltage state and a high temperature state of the secondary side of the DC/DC converter.

5. The feedback circuit of claim 1, further comprising an abnormality detection circuit which is configured to determine whether the abnormality is present in the secondary side and assert an abnormality detection signal when the abnormality is detected,
wherein the protection circuit draws the second current when the abnormality detection signal is asserted.

6. The feedback circuit of claim 5, further comprising a sense terminal to which a sense signal indicating a state of the secondary side of the DC/DC converter is input,
wherein the abnormality detection circuit determines whether the abnormality is present, based on an electrical state of the sense terminal.

7. The feedback circuit of claim 1, further comprising:
a sense terminal to which a sense signal indicating a state of the secondary side of the DC/DC converter is input; and
an abnormality detection comparator configured to compare a voltage of the sense terminal with a predetermined threshold voltage and generate an abnormality detection signal indicating a result of the comparison,
wherein the protection circuit draws the second current when the abnormality detection signal is asserted.

8. The feedback circuit of claim 7, wherein an overvoltage detection signal corresponding to an output voltage of the DC/DC converter is input to the sense terminal, and
wherein the abnormality detection comparator detects an overvoltage state.

9. The feedback circuit of claim 7, wherein a temperature sensing element is connected to the sense terminal, and
wherein the abnormality detection comparator detects high temperature abnormality.

10. The feedback circuit of claim 1, wherein the shunt regulator includes:
a differential amplifier configured to amplify the error between the voltage detection signal and its target voltage; and
an output transistor having one end connected to the output terminal, the other end connected to the ground terminal, and a control terminal to which an output signal of the differential amplifier is input.

11. A DC/DC converter comprising:
a transformer having a primary winding and a secondary winding;
a switching transistor connected to the primary winding of the transformer;
a rectification element connected to the secondary winding of the transformer;
a photo coupler;
a primary side controller which is connected to an output side of the photo coupler and is configured to switch the switching transistor in response to a feedback signal from the photo coupler; and
the feedback circuit of claim 1, which is configured to drive the photo coupler.

12. A power supply device comprising:
a filter configured to filter a commercial AC voltage;
a diode rectification circuit configured to full-wave rectify an output voltage of the filter;
a smoothing capacitor configured to generate a DC input voltage by smoothing an output voltage of the diode rectification circuit; and
the DC/DC converter of claim 11, which is configured to drop down the DC input voltage and supply the dropped-down voltage to a load.

13. An electronic device comprising:
a load;
a filter configured to filter a commercial AC voltage;
a diode rectification circuit configured to full-wave rectify an output voltage of the filter;
a smoothing capacitor configured to generate a DC input voltage by smoothing an output voltage of the diode rectification circuit; and
the DC/DC converter of claim 11, which is configured to drop down the DC input voltage and supply the dropped-down DC input voltage to the load.

14. A power supply adaptor comprising:
a filter configured to filter a commercial AC voltage;
a diode rectification circuit configured to full-wave rectify an output voltage of the filter;
a smoothing capacitor configured to generate a DC input voltage by smoothing an output voltage of the diode rectification circuit; and
the DC/DC converter of claim 11, which is configured to drop down the DC input voltage to generate a DC output voltage.
